(19) United States
(12) Patent Application Publication
(10) Pub. No.: US 2009/0127500 A1
(43) Pub. Date: May 21, 2009

(54) POLISHING COMPOSITION

(75) Inventors: Tatsuhiko Hirano, Kakamigahara-shi (JP); Hiroshi Asano, Kakamigahara-shi (JP); Katsunobu Hori, Inuyama-shi (JP)

Correspondence Address: VIDAS, ARRETT & STEINKRAUS, P.A., SUITE 400, 6640 SHADY OAK ROAD, EDEN PRAIRIE, MN, 55344, US

(73) Assignee: FUJIMI INCORPORATED, Kiyosu-shi (JP)

(21) Appl. No.: 12/065,423

(22) PCT Filed: Sep. 1, 2006
(86) PCT No.: PCT/JP2006/317304

§ 371 Date: Feb. 29, 2008

(30) Foreign Application Priority Data
Sep. 2, 2005 (JP) 2005-255534
Feb. 28, 2006 (JP) 2006-053242

(51) Int. Cl. C09K 13/00

(52) U.S. Cl. 252/79.1

(57) ABSTRACT

A polishing composition contains a triazole having a 6-membered ring skeleton, a water soluble polymer, an oxidant, and abrasive grains. The triazole has a hydrophobic functional group in the 6-membered ring skeleton. The content of the triazole in the polishing composition is 3 g/L or less. The pH of the polishing composition is 7 or more. The polishing composition is suitably used in polishing for forming wiring of a semiconductor device.

### TECHNICAL FIELD

The present invention relates to a polishing composition to be used in polishing, for example, for forming wiring of a semiconductor device.

### BACKGROUND ART

The wiring of a semiconductor device is formed first by forming a barrier layer and a conductive layer successively in this order on an insulating layer having trenches. Then, at least a portion of the conductive layer (outer portion of the conductive layer) positioned outside the trenches and a portion of the barrier layer (outer portion of the barrier layer) positioned outside the trenches are removed by chemical mechanical polishing. The polishing for removing at least the outer portion of the conductive layer and the outer portion of the barrier layer is usually performed by two separate steps: a first polishing step and a second polishing step. In the first polishing step, the outer portion of the conductive layer is partly removed to expose the upper surface of the barrier layer. In the following second polishing step, at least the remaining outer portion of the conductive layer and the outer portion of the barrier layer are removed to expose the insulating layer and obtain a planer surface.

Patent Document 1 discloses a polishing composition, which contains benzotriazole as a protective film forming agent having a function of forming a protective film on the surface of the conductive layer and which can be used in the second polishing step. However, the polishing composition containing benzotriazole has a problem. When it is used in the second polishing step, organic residue derived from benzotriazole is likely to remain as foreign matter on the surface of an object after being polished.

Patent Document 1: International Publication No. WO 00/39844

### DISCLOSURE OF THE INVENTION

An objective of the present invention is to provide a polishing composition which is more suitably used in polishing for forming wiring of a semiconductor device.

To achieve the foregoing objective and in accordance with one aspect of the invention, a polishing composition containing a triazole having a 6-membered ring skeleton, a water soluble polymer, an oxidant, and abrasive grains is provided. The triazole has a hydrophobic functional group in the 6-membered ring skeleton. The content of the triazole in the polishing composition is 3 g/L or less. The pH of the polishing composition is 7 or more.

According to another aspect of the invention, a polishing composition containing a first triazole having a 6-membered ring skeleton, a second triazole having a 6-membered ring skeleton, a water soluble polymer, an oxidant, and abrasive grains is provided. The first triazole has a hydrophobic functional group in the 6-membered ring skeleton. The second triazole has a functional group in the 6-membered ring skeleton. The total content of the first and the second triazoles is 3 g/L or less. The pH of the polishing composition is 7 or more.

### BRIEF DESCRIPTION OF THE DRAWINGS

FIGS. 1(a), 1(b), and 1(c) are cross-sectional views of an object to be polished for explaining a method for forming wiring of a semiconductor device;

FIG. 2(a) is a cross-sectional view of an object to be polished for illustrating dishing and fang; and

FIG. 2(b) is a cross-sectional view of an object to be polished for illustrating reverse-dishing.

### BEST MODE FOR CARRYING OUT THE INVENTION

One embodiment will now be explained below.

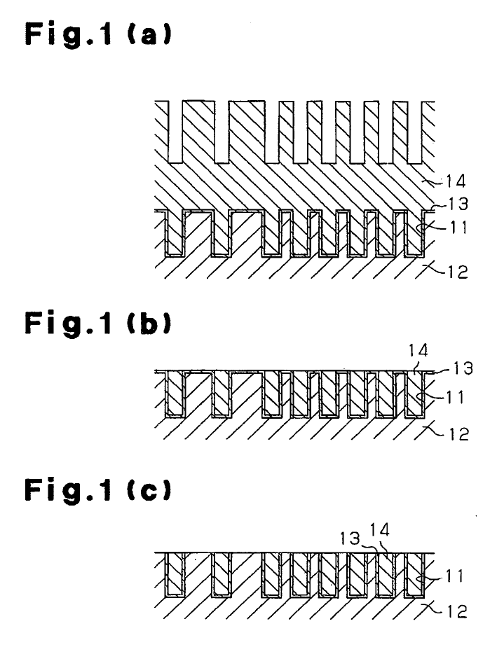

First, a method for forming wiring of a semiconductor device will be explained in accordance with FIGS. 1(a) to 1(c). The wiring of a semiconductor device is usually formed as follows. First, as shown in FIG. 1(a), on an insulating layer 12 formed on a semiconductor substrate (not shown) and having trenches 11, a barrier layer 13 and a conductive layer 14 are successively formed in this order. Thereafter, at least a portion of the conductive layer 14 (outer portion of the conductive layer 14) positioned outside the trenches 11 and a portion of the barrier layer 13 (outer portion of the barrier layer 13) positioned outside the trenches are removed by chemical mechanical polishing. As a result, as shown in FIG. 1(c), at least a part of a portion of the barrier layer 13 (inner portion of the barrier layer 13) positioned within the trenches 11 and at least a part of a portion of the conductive layer 14 (inner portion of the conductive layer 14) positioned within the trenches 11 remain on the insulating layer 12. The portion of the conductive layer 14 remaining on the insulating layer 12 comes to function as wiring of a semiconductor device.

The insulating layer 12 is formed of, for example, silicon dioxide, silicon dioxide doped with fluorine (SiOF), or silicon dioxide doped with carbon (SiOC).

Before the conductive layer 14 is formed, the barrier layer 13 is formed on the insulating layer 12 so as to cover over the surface of the insulating layer 12. The barrier layer 13 is formed of, for example, tantalum, a tantalum alloy, or tantalum nitride. The thickness of the barrier layer 13 is lower than the depth of the trenches 11.

After the barrier layer 13 is formed, the conductive layer 14 is formed on the barrier layer 13 so as at least to bury trenches 11. The conductive layer 14 is formed of, for example, copper or a copper alloy.

When at least the outer portion of the conductive layer 14 and the outer portion of the barrier layer 13 are removed by chemical mechanical polishing, first, the outer portion of the conductive layer 14 is partially removed so as to expose the upper surface of the outer portion of the barrier layer 13, as shown in FIG. 1(b) (first polishing step). Thereafter, as shown in FIG. 1(c), at least the remaining outer portion of the conductive layer 14 and the outer portion of the barrier layer 13 are removed so as to expose the insulating layer 12 and obtain a planar surface (second polishing step). A polishing composition of the embodiment is used in polishing for forming wiring of a semiconductor device, more specifically, particularly suitable for use in the second polishing step.

The polishing composition of the embodiment is produced by blending a predetermined triazole having a 6-membered ring skeleton, a water soluble polymer, an oxidant, abrasive grains, and water so as to obtain a pH of 7 or more. Accordingly, the polishing composition of the embodiment is substantially composed of a predetermined triazole having a 6-membered ring skeleton, a water soluble polymer, an oxidant, abrasive grains, and water.

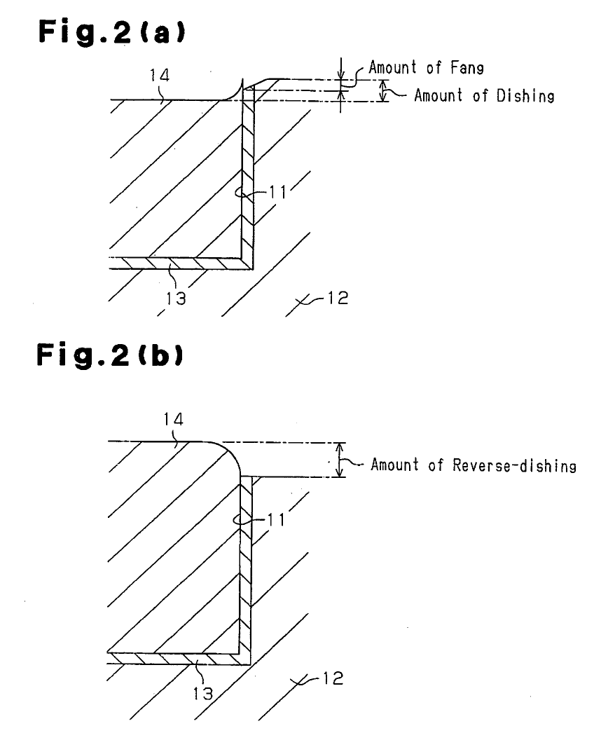

The triazole contained in the polishing composition has a hydrophobic functional group in the 6-membered ring skeleton and functions as a protective film forming agent having a function of forming a protective film on the surface of the conductive layer 14. The protective film formed on the surface of the conductive layer 14 by the function of the triazole contributes to suppressing excessive removal of the inner portion of the conductive layer 14, thereby preventing dishing. The dishing is a phenomenon where the inner portion of the conductive layer 14 is excessively removed and thereby the level of the upper surface of the conductive layer 14 is decreased (see FIG. 2(a)).

In order to obtain a higher protective film forming function, the hydrophobic functional group in the 6-membered ring skeleton of the triazole contained in the polishing composition is preferably an alkyl group and more preferably a methyl group. In other words, the triazole to be contained in the polishing composition is preferably tolyltriazole.

The triazole having a 6-membered ring skeleton having a hydrophobic functional group is less likely to leave organic residue on the surface of an object after being polished, compared to a triazole (e.g., benzotriazole) having a 6-membered ring skeleton with no functional group. This is because the triazole having a 6-membered ring skeleton having a hydrophobic functional group has a strong function of forming a protective film on a surface of the conductive layer 14, compared to a triazole having a 6-membered ring skeleton with no functional group, and thus forms a protective film sufficient to suppress excessive polishing of the conductive layer 14 on the surface of the conductive layer 14, in a relatively small addition amount.

When the content of a triazole in the polishing composition, which triazole has a hydrophobic functional group in a 6-membered ring skeleton, is less than 0.05 g/L, more specifically less than 0.1 g/L, even more specifically less than 0.2 g/L, a sufficient protective film for suppressing excessive polishing of the conductive layer 14 may not be formed on the surface of the conductive layer 14. As a result, dishing may not be suppressed well. Therefore, to strongly suppress dishing, the content of a triazole in the polishing composition, which triazole has a hydrophobic functional group in a 6-membered ring skeleton, is preferably 0.05 g/L or more, more preferably 0.1 g/L or more, and most preferably 0.2 g/L or more. On the other hand, when the content of a triazole in the polishing composition, which triazole has a hydrophobic functional group in a 6-membered ring skeleton, is more than 3 g/L, organic residue derived from the triazole is likely to remain as foreign matter on the surface of an object after being polished, similarly to the case where benzotriazole is used. Therefore, the content of a triazole in the polishing composition, which triazole has a hydrophobic functional group in a 6-membered ring skeleton, must be 3 g/L or less. When the content of a triazole in the polishing composition, which triazole has a hydrophobic functional group in a 6-membered ring skeleton, is more than 2 g/L, and more specifically more than 1 g/L, polishing of the conductive layer 14 may be excessively suppressed since the protective film is excessively formed on the surface of the conductive layer 14. Accordingly, to ensure an appropriate removal rate of polishing the conductive layer 14, the content of a triazole in the polishing composition, which triazole has a hydrophobic functional group in a 6-membered ring skeleton, is preferably 2 g/L or less, and more preferably 1 g/L or less.

The water soluble polymer is contained in order to improve the performance of the polishing composition for polishing the insulating layer 12. The water soluble polymer to be contained in the polishing composition is preferably a polysaccharide, a cellulose derivative, or polyvinyl alcohol (PVA) to polish the insulating layer 12 at a higher removal rate. Of them, any one of pullulan, hydroxyethylcellulose (HEC), carboxymethylcellulose (CMC), and polyvinyl alcohol is more preferable. Ammonium polyacrylate is not preferable since it can induce the phenomenon of dishing.

When the content of a water soluble polymer in the polishing composition is less than 0.01 g/L, more specifically less than 0.1 g/L, and even more specifically less than 1 g/L, the performance of the polishing composition for polishing the insulating layer 12 is not much improved. In addition, a phenomenon called as fang (see FIG. 2(a)) may be induced, where the levels of the upper surfaces of the barrier layer 13 and the insulating layer 12 adjacent to the barrier layer 13 may decrease. Accordingly, to polish the insulating layer 12 at a higher removal rate and to suppress fang, the content of a water soluble polymer in the polishing composition is preferably 0.01 g/L or more, more preferably 0.1 g/L or more, and most preferably 1 g/L or more. On the other hand, the content of a water soluble polymer in the polishing composition is more than 100 g/L, more specifically more than 50 g/L, even more specifically more than 10 g/L, the performance of the polishing composition for polishing the barrier layer 13 may decrease. Accordingly, to polish the barrier layer 13 at a higher removal rate, the content of a water soluble polymer in the polishing composition is preferably 100 g/L or less, more preferably 50 g/L, and most preferably 10 g/L or less.

The oxidant is contained in order to improve the performance of the polishing composition for polishing the barrier layer 13 and the conductive layer 14. The oxidant to be contained in the polishing composition is preferably hydrogen peroxide in order to polish the barrier layer 13 and the conductive layer 14 at higher removal rates.

When the content of an oxidant in the polishing composition is less than 0.1 g/L, more specifically less than 0.3 g/L, and even more specifically less than 0.5 g/L, the performance of the polishing composition for polishing the barrier layer 13 and the conductive layer 14 is not much improved. As a result, a phenomenon called reverse-dishing (see FIG. 2(b)) may be induced, where the portion of the conductive layer 14 to be removed remains without being removed and the upper surface of the conductive layer 14 protrudes. Accordingly, to polish the barrier layer 13 and the conductive layer 14 at higher removal rates, thereby suppressing reverse-dishing, the content of an oxidant in the polishing composition is preferably 0.1 g/L or more, more preferably 0.3 g/L or more, and most preferably 0.5 g/L or more. On the other hand, when the content of an oxidant in the polishing composition is more than 10 g/L, more specifically more than 7 g/L, and even more specifically more than 5 g/L, an oxidation layer may be formed excessively on the surface of the conductive layer 14. As a result, the phenomenon of reverse-dishing may be induced, where the portion of the conductive layer 14 to be removed remains without being removed. Accordingly, to suppress the reverse-dishing, the content of an oxidant in the polishing composition is preferably 10 g/L or less, more preferably 7 g/L or less, and most preferably 5 g/L or less.

The abrasive grains in a polishing composition play a role in mechanically polishing an object and contribute to improving the performance of the polishing composition for polishing the conductive layer 14. The abrasive grains to be contained in a polishing composition may be silica such as powdered calcined silica, fumed silica, and colloidal silica, or alumina such as colloidal alumina. To reduce surface defects of an object after being polished, silica is preferable. Of them, colloidal silica is particularly preferable.

When the content of abrasive grains in the polishing composition is less than 30 g/L, more specifically less than 50 g/L, and even more specifically less than 70 g/L, the performance of the polishing composition for polishing the insulating layer 12, the barrier layer 13, and the conductive layer 14 is not much improved. Accordingly, to polish the insulating layer 12, the barrier layer 13, and the conductive layer 14 at higher removal rates, the content of abrasive grains in the polishing composition is preferably 30 g/L or more, more preferably 50 g/L or more, and most preferably 70 g/L or more. On the other hand, when the content of abrasive grains in the polishing composition is more than 300 g/L, more specifically more than 200 g/L, and even more specifically more than 150 g/L, a further improvement of the removal rate can be hardly obtained. Accordingly, the content of abrasive grains in the polishing composition is preferably 300 g/L or less, more preferably 200 g/L or less and most preferably 150 g/L or less.

Abrasive grains having an average primary particle diameter of less than 10 nm hardly have performance of polishing an object. Accordingly, to polish an object at a higher removal rate, the average primary particle diameter of abrasive grains contained in the polishing composition is preferably 10 nm or more. On the other hand, when the average primary particle diameter of abrasive grains is more than 500 nm, the surface quality of an object after being polished may decrease due to an increase of surface roughness and scratches. Accordingly, to maintain the surface quality of an object after being polished, the average primary particle diameter of abrasive grains is preferably 500 nm or less. The average primary particle diameter of abrasive grains is calculated from the specific surface area of abrasive grains, which is measured, for example, by the BET method.

In particular, when the abrasive grains contained in the polishing composition is colloidal silica, the average primary particle diameter of colloidal silica contained as abrasive grains in the polishing composition may be as follows. When the average primary particle diameter of colloidal silica contained as abrasive grains in the polishing composition is less than 10 nm, more specifically less than 15 nm, and even more specifically less than 20 nm, the performance of the polishing composition for polishing the insulating layer 12, the barrier layer 13, and the conductive layer 14 is not much improved. Accordingly, to polish the insulating layer 12, the barrier layer 13, and the conductive layer 14 at higher removal rates, the average primary particle diameter of colloidal silica contained as abrasive grains in the polishing composition is preferably 10 nm or more, more preferably 15 nm or more, and most preferably 20 nm or more. On the other hand, when the average primary particle diameter of colloidal silica contained as abrasive grains in the polishing composition is more than 100 nm, more specifically more than 70 nm, and even more specifically more than 60 nm, colloidal silica is likely to precipitate and the storage stability of the polishing composition may decrease. Accordingly, to prevent precipitation of colloidal silica, the average primary particle diameter of colloidal silica contained as abrasive grains in the polishing composition is preferably 100 nm or less, more preferably 70 nm or less, and most preferably 60 nm or less.

When the pH of the polishing composition is less than 7, the performance of the polishing composition for polishing the barrier layer 13 is insufficient and abrasive grains in the polishing composition aggregate, and reverse-dishing occurs and thus unfavorable from a practical point of view. Accordingly, the pH of the polishing composition must be 7 or more. On the other hand, when the pH of the polishing composition is excessively high, abrasive grains in the polishing composition may be dissolved. Accordingly, to prevent dissolution of abrasive grains, the pH of the polishing composition is preferably 13 or less, and more preferably 11 or less.

According to the embodiment of the present invention, the following advantages are obtained.

The polishing composition of the embodiment contains a triazole having a hydrophobic functional group in a 6-membered ring skeleton and serving as a protective film forming agent, in an amount of 3 g or less per 1 L of the polishing composition. Therefore, organic residue derived from the protective film forming agent does not largely remain as foreign matter on the surface of an object after being polished, unlike conventional polishing compositions containing benzotriazole as a protective film forming agent. Thus, according to the embodiment, a polishing composition which can be suitably used in polishing for forming wiring of a semiconductor device is provided.

A triazole having a 6-membered ring skeleton with no functional group, such as benzotriazole or 1-(2′,3′-dihydroxypropyl)benzotriazole, has a protective film forming function but insufficient, compared to a triazole having a hydrophobic functional group in a 6-membered ring skeleton. Therefore, when a triazole having a 6-membered ring skeleton with no functional group is used as a protective film forming agent, it must be added in a large amount compared to the case where a triazole having a hydrophobic functional group in a 6-membered ring skeleton is used as a protective film forming agent. As a result, organic residue derived from the protective forming agent is likely to remain as foreign matter on the surface of an object after being polished. In contrast, the polishing composition of the embodiment contains a triazole having a hydrophobic functional group in a 6-membered ring skeleton as a protective film forming agent in place of a triazole having a 6-membered ring skeleton with no functional group, such as benzotriazole or 1,2,4-triazole. Thus, the polishing composition of the embodiment can be suitably used in polishing for forming wiring of a semiconductor device.

The aforementioned embodiment may be modified as follows.

To a polishing composition of the aforementioned embodiment, a triazole having a 6-membered ring skeleton with a hydrophilic functional group may be added. When a triazole having a 6-membered ring skeleton with a hydrophilic functional group is added to the polishing composition, the performance of the polishing composition for polishing the insulating layer 12 and the conductive layer 14 is improved. To polish the insulating layer 12 and the conductive layer 14 at higher removal rates, the hydrophilic functional group in a 6-membered ring skeleton of the triazole is preferably a carboxyl group or an amino group, and more preferably a carboxyl group. More specifically, to polish the insulating layer 12 and the conductive layer 14 at higher removal rates, a triazole having a 6-membered ring skeleton with a hydrophilic functional group to be added to the polishing composition of the aforementioned embodiment, is preferably carboxybenzotriazole or aminobenzotriazole, and more preferably carboxybenzotriazole.

When the content of a triazole having a 6-membered ring skeleton with a hydrophilic functional group in the polishing composition is more than 10 g/L, more specifically more than 7 g/L, and even more specifically more than 5 g/L, the performance of the polishing composition for polishing the conductive layer 14 is excessively high and dishing is likely to occur. In addition, since the performance of the polishing composition for polishing the insulating layer 12 is excessively high, the fang is likely to occur. Therefore, to suppress dishing and fang, the content of a triazole having a 6-membered ring skeleton with a hydrophilic functional group in the polishing composition is preferably 10 g/L or less, more preferably 7 g/L or less and most preferably 5 g/L or less.

To a polishing composition of the aforementioned embodiment, if necessary, a pH adjusting agent may be added. The pH adjusting agent to be added to the polishing composition may be arbitrarily chosen. However, when an alkali metal hydroxide such as potassium hydroxide or alkali such as ammonia is used, the performance of the polishing composition for polishing the barrier layer 13 improves. Furthermore, when an acid such as nitric acid or sulfuric acid in combination with an alkali, the electric conductivity of the polishing composition increases and thereby the performance of the polishing composition for polishing the insulating layer 12 improves. However, when an acid is added as a pH adjusting agent to the polishing composition, the pH of the polishing composition must be 7 or more.

To a polishing composition of the aforementioned embodiment, an amino acid such as glycine or alanine may be added. When an amino acid is added to the polishing composition, the performance of the polishing composition for polishing the conductive layer 14 improves due to chelating function of the amino acid. As a result, reverse-dishing is suppressed. When the content of an amino acid in the polishing composition is more than 5 g/L, more specifically more than 2 g/L, and even more specifically more than 0.5 g/L, the performance of the polishing composition for polishing the conductive layer 14 becomes excessively high. As a result, dishing is likely to occur. Therefore, to suppress dishing, the content of an amino acid in the polishing composition is preferably 5 g/L or less, more preferably 2 g/L or less, and most preferably 0.5 g/L or less.

To a polishing composition of the aforementioned embodiment, a triazole having a 6-membered ring skeleton with no functional group, such as benzotriazole or 1-(2′,3′-dihydroxypropyl)benzotriazole may be added. However, when a triazole having a 6-membered ring skeleton with no functional group is contained in a larger amount in the polishing composition, organic residue derived from the triazole is likely to remain as foreign matter on the surface of an object after being polished. To prevent organic residue from remaining on the surface of an object after being polished without fail, the total content of a triazole having a 6-membered ring skeleton with no functional group and a triazole having a 6-membered ring skeleton having a hydrophobic functional group is preferably set at 3 g/L or less.

To a polishing composition of the embodiment, 1,2,4-triazole, 1H-tetrazole, or 5,5′-bi-1H-tetrazole diammonium salt may be added. However, if each of these azoles is contained in a larger amount in the polishing composition, organic residue derived from the azole largely remains as foreign matter on the surface of an object after being polished or phenomenon of dishing may be induced. Therefore, to avoid such problems, the content of 1,2,4-triazole, 1H-tetrazole, or 5,5′-bi-1H-tetrazole diammonium salt in the polishing composition is preferably less than 1 g/L.

To a polishing composition of the embodiment, known additives such as a preservative and a defoaming agent may be added as needed.

A polishing composition of the aforementioned embodiment may be prepared by diluting a concentrated stock solution before use.

Examples of the present invention and Comparative Examples will now be described.

A triazole, a water soluble polymer, hydrogen peroxide (oxidant), colloidal silica sol, a pH adjusting agent, and an amino acid were appropriately blended and, if necessary, diluted with water to prepare polishing compositions according to Examples 1 to 55 and Comparative Examples 1 to 10. The details of a triazole, a water soluble polymer, hydrogen peroxide, colloidal silica, a pH adjusting agent, and an amino acid in each of the polishing compositions and pH of each polishing composition are shown in Tables 1 to 3.

The numerical values shown in the columns “Copper removal rate”, “Tantalum removal rate,” and “Silicon dioxide removal rate” of Tables 4 and 5 indicate the removal rates when a copper blanket wafer, a tantalum blanket wafer, and a silicon dioxide (TEOS) blanket wafer of 200 mm in diameter were polished by use of the polishing compositions of Examples 1 to 39 and Comparative Examples 1 to 10 under the polishing conditions shown in Table 7. The numerical values in the columns “Copper removal rate”, “Tantalum removal rate,” and “Silicon dioxide removal rate” of Table 6 indicate the removal rates when a copper blanket wafer, a tantalum blanket wafer, and a silicon dioxide (TEOS) blanket wafer of 200 mm in diameter were polished by use of the polishing compositions of Examples 40 to 55 under the polishing conditions shown in Table 8. The removal rate of each wafer was obtained by dividing the difference in thickness of the wafer between before and after polishing by polishing time. The thickness of the copper blanket wafer and tantalum blanket wafer was measured by a sheet resistance measuring apparatus “VR-120” manufactured by International Electric System Service, and the thickness of the silicon dioxide blanket wafer was measured by a thin film measuring apparatus “ASET-F5x” manufactured by KLA Tencor Corporation. The removal rate of the copper blanket wafer by each of the polishing compositions is shown in the column “Copper removal rate”; the removal rate of the tantalum blanket wafer by each of the polishing compositions is shown in the column “Tantalum removal rate”; and the removal rate of the silicon dioxide blanket wafer by each of the polishing compositions is shown in the column “Silicon dioxide removal rate”.

The reference symbols shown in the column “Shelf life” of Tables 4 to 6 indicate the evaluation results of the polishing compositions of Examples 1 to 55 and Comparative Examples 1 to 10 on shelf life. More specifically, a copper blanket wafer, tantalum blanket wafer, and silicon dioxide blanket wafer were polished by use of the polishing compositions of Examples 1 to 39 and Comparative Examples 1 to 10, which were immediately after preparation and stored in air tight containers for a while after the preparation, under the polishing conditions shown in Table 7. Furthermore, a copper blanket wafer, tantalum blanket wafer, and silicon dioxide blanket wafer were polished by use of the polishing compositions of Examples 40 to 55, which were immediately after preparation and stored in air tight containers for a while after the preparation, under the polishing conditions shown in Table 8. In either case, hydrogen peroxide to be contained in a polishing composition was added immediately before use for polishing. Then, the removal rate of each wafer was calculated based on the difference in thickness of the wafer between before and after polishing. Based on the comparison between the removal rate by a polishing composition immediately after preparation and that by a polishing composition stored for a while after preparation, the shelf life of each polishing composition was evaluated. In the column “Shelf life”, ∘ represents that a removal rate half year after preparation still exceeds 80% of that immediately after preparation; represents that a removal rate three months after preparation still exceeds 80% of that immediately after preparation but a removal rate half year after preparation is less than 80% of that immediately after preparation; and x represents that a removal rate three months after preparation is less than 80% of that immediately after preparation.

The reference symbols shown in the column “Corrosiveness” of Tables 4 to 6 indicate the degree of corrosiveness of the polishing compositions of Examples 1 to 55 and Comparative Examples 1 to 10. The degree of corrosiveness was evaluated by a copper pattern wafer (854 mask pattern) manufactured by SEMATEC. The copper pattern wafer, which is formed by providing a tantalum barrier layer and a copper conductive layer of 10,000 Å in thickness successively on a silicon dioxide insulating layer having trenches, has an initial depressed portion of 5,000 Å in depth in the upper surface. First, the copper pattern wafer was subjected to preliminary polishing by use of a polishing material, “PLANERLITE-7105” manufactured by Fujimi Incorporated under the polishing conditions shown in Table 9 until the upper surface of the barrier layer is exposed. Subsequently, the copper pattern wafer preliminary polished was subjected to finish polishing using each of the polishing compositions of Examples 1 to 39 and Comparative Examples 1 to 10 under the polishing conditions shown in Table 7. Alternatively, the copper pattern wafer preliminary polished was subjected to finish polishing using each of the polishing compositions of Examples 40 to 55 under the polishing conditions shown in Table 8. After the finish polishing, the wafer was observed as to the presence or absence of corrosion on the wafer surface by use of a differential interference microscope, “OPTIPHOTO300” manufactured by Nikon Corporation. Based on the observation results, the polishing compositions were evaluated for degrees of corrosiveness. In the column “Corrosiveness”, represents that no corrosion was observed; ∘ represents that corrosion was not substantially observed; and represents that corrosion was slightly observed.

The reference symbols shown in the column “Dishing” of Tables 4 to 6 indicate the evaluation results of improvement degree of dishing when a copper pattern wafer manufactured by SEMATEC (854 mask pattern) was polished by use of each of the polishing compositions of Examples 1 to 55 and Comparative Examples 1 to 10. More specifically, a copper pattern wafer was subjected to preliminary polishing by use of a polishing material “PLANERLITE-7105” under the polishing conditions shown in Table 9 and then subjected to finish polishing using each of polishing compositions of Examples 1 to 39 and Comparative Examples 1 to 10 under the polishing conditions shown in Table 7 or using each of the polishing compositions of Examples 40 to 55 under the polishing conditions shown in Table 8. Before and after the finish polishing, the amount of dishing was measured by use of a contact-type surface measurement apparatus, profiler “HRP340” manufactured by KLA Tencor Corporation in the region of each wafer in which trenches of 100 μm width are independently formed. Based on the value obtained by subtracting the amount of dishing after finish polishing from the amount of dishing before the finish polishing, the improvement degree of dishing by each of the polishing compositions of Examples 1 to 55 and Comparative Examples 1 to 10 was evaluated. In the column “Dishing”, ∘ represents that the value obtained by subtracting the amount of dishing after finish polishing from that before the finish polishing is 20 nm or more; represents 5 nm or more to less than 20 nm; and x represents less than 5 nm.

The reference symbols shown in the column “Fang” of Tables 4 to 6 indicate evaluation results on a degree of fang of the copper pattern wafer (854 mask pattern), which was manufactured by SEMATEC and polished by each of the polishing compositions of Examples 1 to 55 and Comparative Examples 1 to 10. More specifically, a copper pattern wafer was subjected to preliminary polishing by use of a polishing material “PLANERLITE-7105” under the polishing conditions shown in Table 9, as mentioned above and then subjected to finish polishing using each of the polishing compositions of Examples 1 to 39 and Comparative Examples 1 to 10 under the polishing conditions shown in Table 7 or using each of the polishing compositions of Examples 40 to 55 under the polishing conditions shown in Table 8. Thereafter, the amount of fang was measured by use of profiler “HRP340” in the region of each wafer in which trenches of 100 μm width are independently formed. Based on the measurement results, the degree of fang was evaluated. In the column “Fang”, ∘ represents that the amount of fang is less than 5 nm, represents 5 nm or more and less than 10 nm; and x represents 10 nm or more.

The reference symbols shown in the column “Reverse-dishing” of Tables 4 to 6 indicate the measurement results of the presence or absence of fang in a copper pattern wafer (854 mask pattern), which was manufactured by SEMATEC and polished by each of the polishing compositions of Examples 1 to 55 and Comparative Examples 1 to 10. More specifically, a copper pattern wafer was subjected to preliminary polishing by use of a polishing material, “PLANERLITE-7105”, which was manufactured by Fujimi Incorporated under the polishing conditions shown in Table 10 until the upper surface of the barrier layer is exposed, and then subjected to finish polishing using each of the polishing compositions of Examples 1 to 39 and Comparative Examples 1 to 10 under the polishing conditions shown in Table 7 or using the polishing composition of Examples 40 to 55 under the polishing conditions shown in Table 8. After the finish polishing, whether reverse-dishing is present or not was determined in a region of a wafer in which trenches of 100 μm width are independently formed by use of a profiler “HRP 340”. In the column “Reverse-dishing”, ∘ represents that no reverse-dishing was present; represents that reverse-dishing of less than 5 nm was present; and x represents that reverse-dishing of 5 nm or more was present.

The numerical values shown in the column “The number of residual foreign matters” of Tables 4 to 6 indicate the number of foreign matters present on the surface of the copper blanket wafer of 200 nm in diameter after being polished by each of the polishing compositions of Examples 1 to 55 and Comparative Examples 1 to 10. More specifically, a copper blanket wafer was polished for 60 seconds by use of each of the polishing compositions of Examples 1 to 39 and Comparative Examples 1 to 10 under the polishing conditions shown in Table 7 or by use of each of the polishing compositions of Examples 40 to 55 for 60 seconds under the polishing conditions shown in Table 8. Subsequently, the copper blanket wafer after being polished was washed with a washing solution “MCX-SDR4” manufactured by Mitsubishi Chemical Corporation. Thereafter, the number of foreign matters of 0.2 μm or more in size and present on the surface of the wafer was counted by use of a surface foreign matter detection apparatus, Surfscan SP1TBI, manufactured by KLA Tencor Corporation.

TABLE 1

| | | | | | | | | (E) | | | | | | |
|---|---|---|---|---|---|---|---|---|---|---|---|---|---|---|
| | | | | | | | | Colloidal silica | | | | | | |
| | | | | | (C) | | (D) | Average | | (F) | | | | |
| | (A) | | (B) | | Water soluble | | Hydrogen | primary | | pH adjusting | | (G) | | |
| | Triazole | | Triazole | | polymer | | peroxide | particle | | agent | | Amino acid | | |
| | | Content | | Content | | Content | Content | diameter | Content | | Content | | Content | |
| | Name | [g/L] | Name | [g/L] | Name | [g/L] | [g/L] | [nm] | [g/L] | Name | [g/L] | Name | [g/L] | pH |
| Ex. 1 | A1 | 1 | B1 | 3 | C1 | 2 | 1.6 | 30 | 100 | F1 | 0.9 | — | 0 | 8.3 |
| Ex. 2 | A1 | 1 | B1 | 3 | C1 | 5 | 3.0 | 30 | 100 | F1 | 0.9 | — | 0 | 8.0 |
| Ex. 3 | A1 | 1 | B1 | 3 | C1 | 2 | 1.6 | 30 | 100 | F1 | 1.5 | — | 0 | 8.9 |
| Ex. 4 | A1 | 1 | B1 | 3 | C1 | 2 | 1.6 | 30 | 100 | F1 | 1.5 | — | 0 | 8.9 |
| | A2 | 0.5 | | | | | | | | | | | | |
| Ex. 5 | A1 | 1 | B1 | 3 | C1 | 2 | 1.6 | 30 | 100 | F1 | 2.0 | — | 0 | 9.3 |
| Ex. 6 | A1 | 1 | B1 | 2 | C1 | 5 | 1.6 | 50 | 100 | F1 | 1.5 | — | 0 | 9.0 |
| Ex. 7 | A1 | 1 | B1 | 2 | C1 | 5 | 1.6 | 90 | 100 | F1 | 1.5 | — | 0 | 9.0 |
| Ex. 8 | A1 | 1 | B1 | 3 | C1 | 2 | 1.6 | 30 | 80 | F1 | 1.5 | — | 0 | 9.0 |
| Ex. 9 | A1 | 1 | B1 | 3 | C1 | 2 | 1.6 | 30 | 120 | F1 | 1.5 | — | 0 | 8.8 |
| Ex. 10 | A1 | 1 | B1 | 3 | C1 | 2 | 1.6 | 30 | 160 | F1 | 1.5 | — | 0 | 8.7 |
| Ex. 11 | A1 | 1 | B1 | 2 | C1 | 5 | 0.3 | 30 | 100 | F1 | 1.5 | — | 0 | 9.0 |
| Ex. 12 | A1 | 1 | B1 | 2 | C1 | 5 | 2.2 | 30 | 100 | F1 | 1.5 | — | 0 | 9.0 |
| Ex. 13 | A1 | 0.5 | B1 | 3 | C1 | 2 | 1.6 | 30 | 100 | F1 | 1.5 | — | 0 | 8.9 |
| Ex. 14 | A1 | 1.5 | B1 | 3 | C1 | 2 | 1.6 | 30 | 100 | F1 | 1.5 | — | 0 | 8.9 |
| Ex. 15 | A1 | 2 | B1 | 3 | C1 | 2 | 1.6 | 30 | 100 | F1 | 1.5 | — | 0 | 8.9 |
| Ex. 16 | A1 | 1 | — | 0 | C1 | 2 | 1.6 | 30 | 100 | F1 | 1.5 | — | 0 | 9.3 |
| Ex. 17 | A1 | 1 | B1 | 1 | C1 | 2 | 1.6 | 30 | 100 | F1 | 1.5 | — | 0 | 9.1 |
| Ex. 18 | A1 | 1 | B1 | 2 | C1 | 2 | 1.6 | 30 | 100 | F1 | 1.5 | — | 0 | 9.0 |
| Ex. 19 | A1 | 1 | B1 | 4 | C1 | 2 | 1.6 | 30 | 100 | F1 | 1.5 | — | 0 | 8.7 |
| Ex. 20 | A1 | 1 | B1 | 3 | C1 | 1 | 1.6 | 30 | 100 | F1 | 1.5 | — | 0 | 8.9 |
| Ex. 21 | A1 | 1 | B1 | 3 | C1 | 3 | 1.6 | 30 | 100 | F1 | 1.5 | — | 0 | 8.9 |
| Ex. 22 | A1 | 1 | B1 | 2 | C1 | 10 | 1.6 | 30 | 100 | F1 | 1.5 | — | 0 | 9.0 |
| Ex. 23 | A1 | 1 | B1 | 3 | C1 | 2 | 1.6 | 30 | 100 | F2 | 1.4 | — | 0 | 8.7 |
| Ex. 24 | A1 | 1 | B1 | 3 | C1 | 2 | 1.6 | 30 | 100 | F2 | 2.4 | — | 0 | 9.3 |
| Ex. 25 | A1 | 1 | B1 | 3 | C1 | 2 | 1.6 | 30 | 100 | F2 | 3.4 | — | 0 | 9.8 |
| Ex. 26 | A1 | 1 | B1 | 3 | C1 | 2 | 1.6 | 30 | 100 | F2 | 4.8 | — | 0 | 10.7 |
| Ex. 27 | A1 | 1 | B1 | 3 | C2 | 1 | 1.6 | 30 | 100 | F1 | 1.5 | — | 0 | 8.9 |
| Ex. 28 | A1 | 1 | B1 | 3 | C3 | 0.5 | 1.6 | 30 | 100 | F1 | 1.5 | — | 0 | 8.9 |
| Ex. 29 | A1 | 1 | B1 | 3 | C4 | 0.5 | 1.6 | 30 | 100 | F1 | 1.5 | — | 0 | 8.9 |

TABLE 2

| | | | | | | | | (E) | | | | | | |
|---|---|---|---|---|---|---|---|---|---|---|---|---|---|---|
| | | | | | | | | Colloidal silica | | | | | | |
| | | | | | (C) | | (D) | Average | | (F) | | | | |
| | (A) | | (B) | | Water soluble | | Hydrogen | primary | | pH adjusting | | (G) | | |
| | Triazole | | Triazole | | polymer | | peroxide | particle | | agent | | Amino acid | | |
| | | Content | | Content | | Content | Content | diameter | Content | | Content | | Content | |
| | Name | [g/L] | Name | [g/L] | Name | [g/L] | [g/L] | [nm] | [g/L] | Name | [g/L] | Name | [g/L] | pH |
| Ex. 30 | A1 | 0.5 | — | 0 | C1 | 2 | 1.6 | 30 | 100 | F1 | 1.5 | — | 0 | 7.6 |
| | | | | | | | | | | F3 | 3.0 | | | |
| Ex. 31 | A1 | 0.2 | — | 0 | C1 | 2 | 1.6 | 30 | 100 | F1 | 1.5 | — | 0 | 7.6 |
| | | | | | | | | | | F3 | 3.0 | | | |
| Ex. 32 | A1 | 0.2 | — | 0 | C1 | 2 | 1.6 | 30 | 100 | F1 | 1.5 | — | 0 | 8.7 |
| | | | | | | | | | | F3 | 1.8 | | | |
| Ex. 33 | A1 | 0.2 | — | 0 | C1 | 2 | 1.6 | 30 | 100 | F1 | 1.5 | — | 0 | 9.2 |
| | | | | | | | | | | F3 | 1.0 | | | |
| Ex. 34 | A1 | 0.2 | — | 0 | C1 | 2 | 1.6 | 30 | 100 | F1 | 1.5 | G1 | 0.1 | 7.6 |
| | | | | | | | | | | F3 | 3.0 | | | |
| Ex. 35 | A1 | 0.2 | — | 0 | C1 | 2 | 1.6 | 30 | 100 | F1 | 1.5 | G1 | 0.4 | 7.6 |
| | | | | | | | | | | F3 | 3.0 | | | |
| Ex. 36 | A1 | 0.5 | — | 0 | C1 | 2 | 1.6 | 30 | 100 | F1 | 1.5 | G1 | 0.1 | 7.5 |
| | | | | | | | | | | F3 | 3.0 | | | |
| Ex. 37 | A1 | 0.5 | — | 0 | C1 | 2 | 1.6 | 30 | 100 | F1 | 1.5 | G1 | 0.4 | 7.5 |
| | | | | | | | | | | F3 | 3.0 | | | |
| Ex. 38 | A1 | 0.5 | — | 0 | C1 | 2 | 1.6 | 30 | 100 | F1 | 1.5 | G1 | 0.1 | 9.4 |
| Ex. 39 | A1 | 0.5 | — | 0 | C1 | 2 | 1.6 | 30 | 100 | F1 | 1.5 | G1 | 0.4 | 9.3 |
| C. Ex. 1 | — | 0 | B1 | 2 | C1 | 2 | 1.6 | 30 | 100 | F1 | 2.2 | — | 0 | 9.5 |
| C. Ex. 2 | A1 | 1 | — | 0 | — | 0 | 1.6 | 30 | 100 | F1 | 0.9 | — | 0 | 8.5 |
| C. Ex. 3 | A1 | 1 | B1 | 3 | — | 0 | 1.6 | 30 | 100 | F1 | 1.5 | — | 0 | 8.9 |
| C. Ex. 4 | A2 | 1 | — | 0 | — | 0 | 1.6 | 30 | 100 | F1 | 0.9 | — | 0 | 8.4 |
| C. Ex. 5 | A2 | 1 | — | 0 | C5 | 2 | 1.6 | 30 | 100 | F1 | 0.9 | — | 0 | 8.3 |
| C. Ex. 6 | A2 | 1 | B1 | 3 | C1 | 2 | 1.6 | 30 | 100 | F1 | 0.9 | — | 0 | 8.9 |
| C. Ex. 7 | A2 | 1 | — | 0 | C1 | 2 | 1.6 | 30 | 100 | F1 | 0.9 | — | 0 | 8.9 |
| | A3 | 1 | | | | | | | | | | | | |
| C. Ex. 8 | A2 | 3.5 | — | 0 | C1 | 2 | 1.6 | 30 | 100 | F4 | 7.0 | — | 0 | 3.0 |
| C. Ex. 9 | A2 | 1 | — | 0 | C1 | 2 | 1.6 | 30 | 100 | F5 | 1.5 | — | 0 | 2.0 |
| C. Ex. | A1 | 1 | — | 0 | C1 | 2 | 1.6 | 30 | 100 | F1 | 0.9 | — | 0 | 9.5 |
| 10 | A2 | 3 | | | | | | | | | | | | |

TABLE 3

| | | | | | | | | (E) | | | | | | |
|---|---|---|---|---|---|---|---|---|---|---|---|---|---|---|
| | | | | | | | | Colloidal silica | | | | | | |
| | | | | | (C) | | (D) | Average | | (F) | | | | |
| | (A) | | (B) | | Water soluble | | Hydrogen | primary | | pH adjusting | | (G) | | |
| | Triazole | | Triazole | | polymer | | peroxide | particle | | agent | | Amino acid | | |
| | | Content | | Content | | Content | Content | diameter | Content | | Content | | Content | |
| | Name | [g/L] | Name | [g/L] | Name | [g/L] | [g/L] | [nm] | [g/L] | Name | [g/L] | Name | [g/L] | pH |
| Ex. 40 | A1 | 0.5 | B1 | 1.5 | C1 | 4 | 3.0 | 30 | 100 | F1 | 0.5 | — | 0 | 7.5 |
| Ex. 41 | A1 | 0.2 | B1 | 2.0 | C1 | 4 | 3.0 | 30 | 100 | F1 | 0.5 | — | 0 | 7.6 |
| Ex. 42 | A1 | 0.2 | B1 | 2.0 | C1 | 6 | 3.0 | 30 | 100 | F1 | 0.5 | — | 0 | 7.4 |
| Ex. 43 | A1 | 0.2 | — | 0 | C1 | 4 | 3.0 | 30 | 100 | F1 | 1.0 | — | 0 | 8.2 |
| | | | | | | | | | | F3 | 1.0 | | | |
| Ex. 44 | A1 | 0.2 | — | 0 | C1 | 4 | 3.0 | 30 | 100 | F1 | 0.5 | — | 0 | 7.4 |
| | | | | | | | | | | F3 | 1.0 | | | |
| Ex. 45 | A1 | 0.2 | — | 0 | C1 | 4 | 3.0 | 30 | 100 | F1 | 1.5 | — | 0 | 9.2 |
| | | | | | | | | | | F3 | 1.0 | | | |
| Ex. 46 | A1 | 0.2 | B1 | 0.2 | C1 | 4 | 3.0 | 30 | 100 | F1 | 0.5 | — | 0 | 7.3 |
| | | | | | | | | | | F3 | 1.0 | | | |
| Ex. 47 | A1 | 0.2 | B1 | 0.2 | C1 | 4 | 3.0 | 30 | 100 | F1 | 0.5 | — | 0 | 7.3 |
| | | | | | | | | | | F3 | 0.9 | | | |
| Ex. 48 | A1 | 0.2 | B1 | 0.2 | C1 | 4 | 4.5 | 30 | 100 | F1 | 0.5 | — | 0 | 7.2 |
| | | | | | | | | | | F3 | 0.8 | | | |
| Ex. 49 | A1 | 0.2 | B1 | 0.2 | C1 | 4 | 4.5 | 30 | 100 | F1 | 0.5 | — | 0 | 7.1 |
| | | | | | | | | | | F3 | 0.7 | | | |
| Ex. 50 | A1 | 0.2 | — | 0 | C1 | 4 | 3.0 | 30 | 100 | F1 | 0.5 | G1 | 0.1 | 7.4 |
| | | | | | | | | | | F3 | 1.0 | | | |
| Ex. 51 | A1 | 0.2 | — | 0 | C1 | 4 | 3.0 | 30 | 100 | F1 | 0.5 | G1 | 0.3 | 7.4 |
| | | | | | | | | | | F3 | 1.0 | | | |
| Ex. 52 | A1 | 0.2 | — | 0 | C1 | 4 | 3.0 | 30 | 100 | F1 | 0.5 | G1 | 0.4 | 7.4 |
| | | | | | | | | | | F3 | 1.0 | | | |
| Ex. 53 | A1 | 0.2 | — | 0 | C1 | 4 | 3.0 | 30 | 100 | F1 | 0.5 | G1 | 0.5 | 7.4 |
| | | | | | | | | | | F3 | 1.0 | | | |
| Ex. 54 | A1 | 0.2 | — | 0 | C1 | 4 | 4.5 | 30 | 100 | F1 | 0.5 | G1 | 0.4 | 7.4 |
| | | | | | | | | | | F3 | 1.0 | | | |
| Ex. 55 | A1 | 0.2 | — | 0 | C1 | 4 | 6.0 | 30 | 100 | F1 | 0.5 | G1 | 0.4 | 7.4 |
| | | | | | | | | | | F3 | 1.0 | | | |

In Tables 1 to 3, reference symbol A1 represents tolyltriazole, A2 represents benzotriazole, A3 represents 1,2,4-triazole, and B1 represents carboxybenzotriazole. Furthermore, reference symbol C1 represents pullulan, C2 represents polyvinyl alcohol, C3 represents hydroxyethylcellulose, C4 represents carboxymethylcellulose, C5 represents ammonium polyacrylate, F1 represents ammonia, F2 represents potassium hydroxide, F3 represents nitric acid, F4 represents malic acid, F5 represents citric acid, and G1 represents glycine.

TABLE 4

| | | Tantalum | | | | | | | The number of |
|---|---|---|---|---|---|---|---|---|---|
| | Copper | removal | Silicon dioxide | | | | | | residual foreign |
| | removal rate | rate | removal rate | | | | | | matters |
| | [nm/min] | [nm/min] | [nm/min] | Shelf life | Corrosiveness | Dishing | Fang | Reverse-dishing | (×10²) |
| Ex. 1 | 44 | 51 | 38 | ∘ | ∘ | ∘ | ∘ | ∘ | 5 |
| Ex. 2 | 53 | 62 | 37 | ∘ | ∘ | ∘ | ∘ | ∘ | 7 |
| Ex. 3 | 53 | 58 | 38 | ∘ | ∘ | ∘ | ∘ | ∘ | 6 |
| Ex. 4 | 50 | 53 | 40 | ∘ | ∘ | ∘ | ∘ | ∘ | 6 |
| Ex. 5 | 60 | 59 | 41 | ∘ | ∘ | ∘ | ∘ | ∘ | 6 |
| Ex. 6 | 52 | 55 | 38 | ∘ | ∘ | ∘ | ∘ | ∘ | 6 |
| Ex. 7 | 37 | 45 | 38 | ∘ | ∘ | ∘ | ∘ | ∘ | 6 |
| Ex. 8 | 53 | 55 | 30 | ∘ | ∘ | ∘ | ∘ | ∘ | 6 |
| Ex. 9 | 52 | 57 | 41 | ∘ | ∘ | ∘ | ∘ | ∘ | 6 |
| Ex. 10 | 52 | 56 | 45 | ∘ | ∘ | ∘ | ∘ | ∘ | 5 |
| Ex. 11 | 33 | 45 | 44 | ∘ | ∘ | ∘ | ∘ | ∘ | 4 |
| Ex. 12 | 31 | 62 | 43 | ∘ | ∘ | | ∘ | ∘ | 6 |
| Ex. 13 | 57 | 56 | 37 | ∘ | ∘ | ∘ | ∘ | ∘ | 2 |
| Ex. 14 | 48 | 57 | 43 | ∘ | ∘ | ∘ | ∘ | ∘ | 7 |
| Ex. 15 | 45 | 55 | 45 | ∘ | ∘ | ∘ | ∘ | ∘ | 9 |
| Ex. 16 | 29 | 47 | 28 | ∘ | ∘ | ∘ | ∘ | ∘ | 9 |
| Ex. 17 | 51 | 56 | 41 | ∘ | ∘ | ∘ | ∘ | ∘ | 6 |
| Ex. 18 | 55 | 57 | 36 | ∘ | ∘ | ∘ | ∘ | ∘ | 6 |
| Ex. 19 | 50 | 54 | 39 | ∘ | ∘ | ∘ | | ∘ | 6 |
| Ex. 20 | 53 | 53 | 34 | ∘ | ∘ | ∘ | ∘ | ∘ | 8 |
| Ex. 21 | 53 | 61 | 48 | ∘ | ∘ | ∘ | ∘ | ∘ | 6 |
| Ex. 22 | 54 | 50 | 51 | ∘ | ∘ | ∘ | ∘ | ∘ | 5 |
| Ex. 23 | 44 | 51 | 38 | ∘ | ∘ | ∘ | ∘ | ∘ | 5 |
| Ex. 24 | 50 | 55 | 40 | ∘ | ∘ | ∘ | ∘ | ∘ | 6 |
| Ex. 25 | 40 | 53 | 48 | ∘ | ∘ | ∘ | ∘ | ∘ | 6 |
| Ex. 26 | 30 | 56 | 52 | ∘ | | ∘ | ∘ | ∘ | 7 |
| Ex. 27 | 45 | 55 | 35 | ∘ | ∘ | ∘ | ∘ | ∘ | 10 |
| Ex. 28 | 55 | 47 | 33 | ∘ | ∘ | ∘ | ∘ | ∘ | 9 |
| Ex. 29 | 30 | 50 | 55 | ∘ | ∘ | ∘ | ∘ | ∘ | 8 |
| Ex. 30 | 28 | 50 | 42 | ∘ | ∘ | ∘ | ∘ | ∘ | 2 |
| Ex. 31 | 35 | 51 | 40 | ∘ | | | ∘ | ∘ | 1 |
| Ex. 32 | 30 | 50 | 38 | ∘ | | | ∘ | ∘ | 1 |
| Ex. 33 | 32 | 41 | 16 | ∘ | | | ∘ | ∘ | 1 |
| Ex. 34 | 61 | 49 | 32 | ∘ | | | ∘ | ∘ | 0.7 |
| Ex. 35 | 93 | 41 | 36 | ∘ | | | ∘ | ∘ | 0.6 |
| Ex. 36 | 39 | 49 | 34 | ∘ | ∘ | ∘ | ∘ | ∘ | 1.5 |
| Ex. 37 | 47 | 42 | 37 | ∘ | ∘ | | ∘ | ∘ | 1.5 |
| Ex. 38 | 45 | 54 | 17 | ∘ | ∘ | | ∘ | ∘ | 1.5 |
| Ex. 39 | 55 | 51 | 18 | ∘ | ∘ | | ∘ | ∘ | 1.5 |

TABLE 5

| | | Tantalum | | | | | | | The number of |
|---|---|---|---|---|---|---|---|---|---|
| | Copper | removal | Silicon dioxide | | | | | | residual foreign |
| | removal rate | rate | removal rate | | | | | | matters |
| | [nm/min] | [nm/min] | [nm/min] | Shelf life | Corrosiveness | Dishing | Fang | Reverse-dishing | (×10²) |
| C. Ex. 1 | 497 | 40 | 73 | ∘ | ∘ | x | ∘ | ∘ | 2 |
| C. Ex. 2 | 3 | 40 | 18 | ∘ | ∘ | ∘ | x | ∘ | 183 |
| C. Ex. 3 | 3 | 42 | 20 | ∘ | ∘ | ∘ | x | ∘ | 30 |
| C. Ex. 4 | 5 | 40 | 18 | ∘ | ∘ | ∘ | x | ∘ | 100 |
| C. Ex. 5 | 40 | 29 | 32 | | ∘ | x | ∘ | ∘ | 7 |
| C. Ex. 6 | 85 | 57 | 38 | ∘ | ∘ | x | ∘ | ∘ | 6 |
| C. Ex. 7 | 50 | 50 | 38 | ∘ | ∘ | x | ∘ | ∘ | 6 |
| C. Ex. 8 | 34 | 45 | 85 | x | ∘ | ∘ | ∘ | x | 2 |
| C. Ex. 9 | 40 | 48 | 80 | x | ∘ | ∘ | ∘ | x | 2 |
| C. Ex. 10 | 20 | 40 | 35 | ∘ | ∘ | ∘ | ∘ | ∘ | 90 |

TABLE 6

| | | Tantalum | | | | | | | The number of |
|---|---|---|---|---|---|---|---|---|---|
| | Copper | removal | Silicon dioxide | | | | | | residual foreign |
| | removal rate | rate | removal rate | | | | | | matters |
| | [nm/min] | [nm/min] | [nm/min] | Shelf life | Corrosiveness | Dishing | Fang | Reverse-dishing | (×10²) |
| Ex. 40 | 115 | 73 | 80 | ∘ | ∘ | ∘ | ∘ | ∘ | 2 |
| Ex. 41 | 114 | 79 | 84 | ∘ | ∘ | ∘ | ∘ | ∘ | 1 |
| Ex. 42 | 111 | 66 | 75 | ∘ | ∘ | ∘ | ∘ | ∘ | 1 |
| Ex. 43 | 40 | 60 | 72 | ∘ | | ∘ | ∘ | | 1.2 |
| Ex. 44 | 36 | 58 | 71 | ∘ | | ∘ | ∘ | | 1.2 |
| Ex. 45 | 43 | 62 | 72 | ∘ | | ∘ | ∘ | | 1.2 |
| Ex. 46 | 51 | 47 | 70 | ∘ | | ∘ | ∘ | ∘ | 1 |
| Ex. 47 | 51 | 47 | 65 | ∘ | | ∘ | ∘ | ∘ | 1 |
| Ex. 48 | 53 | 69 | 71 | ∘ | | ∘ | ∘ | ∘ | 1 |
| Ex. 49 | 79 | 62 | 74 | ∘ | ∘ | ∘ | ∘ | ∘ | 1 |
| Ex. 50 | 26 | 37 | 54 | ∘ | | ∘ | ∘ | ∘ | 0.8 |
| Ex. 51 | 24 | 34 | 50 | ∘ | | | ∘ | ∘ | 0.8 |
| Ex. 52 | 51 | 59 | 70 | ∘ | | | ∘ | ∘ | 0.8 |
| Ex. 53 | 47 | 42 | 62 | ∘ | | | ∘ | ∘ | 0.6 |
| Ex. 54 | 43 | 62 | 70 | ∘ | | | ∘ | ∘ | 0.8 |
| Ex. 55 | 41 | 67 | 70 | ∘ | | | | ∘ | 0.6 |

TABLE 7
Polishing machine: Single-sided CMP polishing machine “Mirra”
manufactured by Applied Materials Inc.
Polishing pad: laminate polishing pad “IC-1400” made of polyurethane
and manufactured by Rohm and Haas
Polishing pressure: about 28 kPa (=2 psi)
Rotation speed of machine platen: 80 rpm
Feed speed of polishing composition: 200 mL/min
Carrier rotation speed: 80 rpm

TABLE 8

Polishing machine: Single-sided CMP polishing machine “Mirra”
manufactured by Applied Materials Inc.
Polishing pad: suede pad
Polishing pressure: about 14 kPa (=1 psi)
Rotation speed of machine platen: 90 rpm
Feed speed of polishing composition: 200 mL/min
Carrier rotation speed: 80 rpm

TABLE 9

Polishing machine: Single-sided CMP polishing machine “Mirra”
manufactured by Applied Materials Inc.
Polishing pad: laminate polishing pad “IC-1000/Suba IV” made of
polyurethane and manufactured by Rohm and Haas
Polishing pressure: about 28 kPa (=2 psi)
Rotation speed of machine platen: 100 rpm
Feed speed of polishing composition: 200 mL/min
Carrier rotation speed: 100 rpm

TABLE 10

Polishing machine: Single-sided CMP polishing machine “Mirra”
manufactured by Applied Materials Inc.
Polishing pad: laminate polishing pad “IC-1400” made of
polyurethane and manufactured by Rohm and Haas
Polishing pressure: about 14 kPa (=1 psi)
Rotation speed of machine platen: 60 rpm
Feed speed of polishing composition: 200 mL/min
Carrier rotation speed: 60 rpm

As shown in Tables 4 to 6, the number of foreign matters present on the wafer surface after being polished by each of the polishing compositions of Examples 1 to 55 was suppressed to 10×10² or less. Furthermore, the polishing compositions of Examples 1 to 55 provided practically satisfactory results with respect to removal rate, shelf life, corrosiveness, dishing, fang, and reverse-dishing.

1. A polishing composition comprising:
a triazole having a 6-membered ring skeleton;
a water soluble polymer;
an oxidant; and
abrasive grains,
wherein the triazole has a hydrophobic functional group in the 6-membered ring skeleton, and wherein the content of the triazole in the polishing composition is 3 g/L or less and the pH of the polishing composition is 7 or more.

2. A polishing composition comprising:
a first triazole having a 6-membered ring skeleton;
a second triazole having a 6-membered ring skeleton;
a water soluble polymer;
an oxidant; and
abrasive grains,
wherein the fast triazole has a hydrophobic functional group in the 6-membered ring skeleton, and the second triazole has no functional group in the 6-membered ring skeleton, and wherein the total content of the first and second triazoles in the polishing composition is 3 g/L or less and the pH of the polishing composition is 7 or more.

3. The polishing composition according to claim 1, wherein the hydrophobic functional group is an alkyl group

4. The polishing composition according to claim 1, further comprising another type of triazole having a 6-membered ring skeleton, the triazole having a carboxyl group or an amino group in the 6-membered ring skeleton.

5. The polishing composition according to claim 1, wherein the water soluble polymer is at least one type of compound selected from polysaccharides, cellulose derivatives, and polyvinyl alcohols.

6. The polishing composition according to claim 1, wherein the oxidant is hydrogen peroxide

7. The polishing composition according to claim 2, wherein the hydrophobic functional group is an alkyl group.

8. The polishing composition according to claim 2, further comprising another type of triazole having a 6-membered ring skeleton, the triazole having a carboxyl group or an amino group in the 6-membered ring skeleton.

9. The polishing composition according to claim 2, wherein the water soluble polymer is at least one type of compound selected from polysaccharides, cellulose derivatives, and polyvinyl alcohols

10. The polishing composition according to claim 2, wherein the oxidant is hydrogen peroxide.
